(19) United States
(12) Patent Application Publication
(10) Pub. No.: US 2026/0176485 A1
(43) Pub. Date: Jun. 25, 2026

(54) INK SET AND METHOD FOR PRODUCING PRINTED MATTER

(71) Applicant: RISO KAGAKU CORPORATION, Tokyo (JP)

(72) Inventor: Naoyuki TORITA, Tokyo (JP)

(21) Appl. No.: 19/392,430

(22) Filed: Nov. 18, 2025

(30) Foreign Application Priority Data
Dec. 25, 2024 (JP) 2024-228481

(51) Int. Cl. C09D 11/40; B41M 3/00; C09D 11/36

(52) U.S. Cl. CPC C09D 11/40; B41M 3/008; C09D 11/36

(57) ABSTRACT

An ink set including two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], wherein the two types of inks each include a colorant, a dispersant, and an organic solvent; a ratio of a thixotropic index of an ink (B) (TB) having a higher thixotropic index to a thixotropic index of an ink (A) (TA) having a lower thixotropic index [(TB)/(TA)] is 1.04 or more; and the ink (B) is applied to a print medium to be overlayed on at least a part of an application region of the ink (A) after applying the ink (A) to the print medium.

### CROSS-REFERENCE TO RELATED APPLICATIONS

The present application is based on and claims the benefit of priority from the prior Japanese Patent Application No. 2024-228481, filed on Dec. 25, 2024, the entire contents of which are incorporated by reference herein.

### TECHNICAL FIELD

The present disclosure relates to an ink set and a method of producing printed matter.

### BACKGROUND

Inkjet recording methods have rapidly spread in recent years, enabling low-noise and high-speed printing. In the inkjet recording method, inkjet ink having high fluidity is ejected as droplets from fine nozzles, and an image is recorded on a print medium that is placed facing the nozzles. Inks used in the inkjet recording method include aqueous inks containing water as a main solvent, non-aqueous inks containing a non-aqueous solvent as a main solvent, ultraviolet-curable ink (UV inks) containing a large content of polymerizable monomers as a main component, and hot-melt inks (solid inks) which contain a large content of wax as a main component. Aqueous inks use water as a main solvent, and water-soluble organic solvents are generally used together from the viewpoint of preventing clogging of inkjet nozzles. Non-aqueous inks can be classified into solvent inks in which a main solvent is a volatile organic solvent, and oil-based inks in which a main solvent is a low-volatility or non-volatile organic solvent. While solvent inks dry on a print medium mainly by evaporation of an organic solvent, oil-based inks dry mainly by permeation into the print medium.

As a technology related to inkjet inks, JP 10-168368 A describes that ink bleed can be reduced by using an ink that contains charged particles including a colorant as a main component, a substance having opposite charge, and a medium.

### SUMMARY OF INVENTION

In inkjet printing, there are cases where multiple types of inks are applied in layers on a print medium in order to obtain a desired color tone. In an ink containing an organic solvent such as an aqueous ink and a non-aqueous ink, the ink applied subsequently penetrates into the print medium due to the influence of an organic solvent contained in the ink applied first, resulting in a phenomenon that a sufficient image density cannot be obtained. Furthermore, when the ink penetrates into the print medium significantly, strike-through of the ink occurs. In addition, when the amount of the ink applied subsequently is increased in order to obtain a sufficient image density, the possibility of strike-through of the ink further increases.

One embodiment according to the present disclosure relates to an ink set including two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], wherein the two types of inks each include a colorant, a dispersant, and an organic solvent, a ratio of a thixotropic index of an ink (B) having a higher thixotropic index (TB) to a thixotropic index of an ink (A) having a lower thixotropic index (TA) [(TB)/(TA)] is 1.04 or more; and the ink (B) is applied to a print medium to overlap at least a part of an application region of the ink (A) after applying the ink (A) to the print medium.

Another embodiment according to the present disclosure relates to a method of producing printed matter using two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], the method including applying an ink (A) having a lower thixotropic index to a print medium, and then applying an ink (B) having a higher thixotropic index to a print medium to be overlayed on at least a part of an application region of the ink (A), wherein the two types of inks each including a colorant, a dispersant, and an organic solvent, a ratio of the thixotropic index of an ink (B) (TB) to the thixotropic index of an ink (A) (TA) [(TB)/(TA)] is 1.04 or more; and applying the ink (B) to a print medium to be overlayed on at least a part of an application region of the ink (A) after applying the ink (A) to the print medium.

Another embodiment of the present disclosure relates to an ink set including two types of oil-based inkjet inks having different thixotropic indices calculated by the following formula: thixotropic index=[Viscosity of oil-based inkjet ink measured at 23° C. and at a shear rate of 53.6 s⁻¹]/[Viscosity of oil-based inkjet ink measured at 23° C. and at a shear rate of 1000 s⁻¹], wherein a ratio of a thixotropic index of an oil-based ink (β) having a higher thixotropic index (Tβ) to a thixotropic index of an oil-based ink (α) having a lower thixotropic index (Tα) [(Tβ)/(Tα)] is 1.04 or more.

### DETAILED DESCRIPTION OF THE INVENTION

Hereinafter, several embodiments of the present invention will be described in detail, but the present disclosure is not limited to these embodiments. In the present disclosure, inkjet ink is also referred to as “ink”. Oil-based inkjet ink is also referred to as “oil-based ink”. Acrylic resin is a general term for a resin obtained by polymerizing acrylic acid, methacrylic acid, and derivatives thereof individually or in combination. (Meth)acrylic acid is a general term for acrylic acid and methacrylic acid. (Meth)acrylic acid ester is a general term for acrylic acid ester and methacrylic acid ester.

An ink set according to one embodiment (hereinafter also referred to as an ink set (1)) includes two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], wherein the two types of inks each include a colorant, a dispersant, and an organic solvent; a ratio of a thixotropic index of an ink (B) having a higher thixotropic index (TB) to a thixotropic index of an ink (A) having a lower thixotropic index (TA) [(TB)/(TA)] is 1.04 or more; and the ink (B) is applied to a print medium to be overlayed on at least a part of an application region of the ink (A) after applying the ink (A) to the print medium.

In an ink set (1), when the ratio of the thixotropic index of the ink (B) having a higher thixotropic index (TB) to the thixotropic index of the ink (A) having a lower thixotropic index (TA) [(TB)/(TA)] is 1.04 or more, and when the ink (A) having a lower thixotropic index is applied first, and the ink (B) having a higher thixotropic index is applied subsequently, to a print media, it is possible to reduce penetration of the ink (B) into the print medium due to an influence of an organic solvent contained in the ink (A) applied first. Thus, the colorant contained in the ink (B) sufficiently remains on the surface of the print medium, and printed matter having excellent image density can be obtained. In addition, it is not necessary to apply the ink (B) in excess in order to increase the image density, thereby mitigating strike-through of the ink.

The ratio of the thixotropic indices of the two inks [(TB)/(TA)] is 1.04 or more. An upper limit value of the ratio (TB)/(TA) is not particularly limited, but may be 2 or less, 1.5 or less, or 1.2 or less, for example, from the viewpoint of a balance with ejection performance of the inkjet.

The viscosity value of the ink used for calculating the thixotropic index may be measured in any manner as long as the conditions of temperature and shear rate are satisfied. For example, the viscosity value may be measured using a rheometer “MCR 302” manufactured by Anton Paar GmbH.

The ink (A) included in the ink set (1) and the ink (B) included in the ink set (1) are not particularly limited in terms of the kind of colorant, the color tone, or the like of the ink, and the ink may have any color. In general, inks, which are in a relationship between dark and light, are often applied in layers. As a specific example, the ink (A) may be a dark black ink, and the ink (B) may be a light black ink. Further, the ink (A) and the ink (B) may have the same hue; and the ink (A) may be a dark-colored ink and the ink (B) may be a light-colored ink. In the present disclosure, when two or more types of inks have the same hue, it means that the hue angle of the Ostwalt hue circle is within 45°. The hues of the ink (A) and the ink (B) may have the hue angle of the Ostwalt hue circle within 45°, within 30°, or within 15°. The shade of the ink can be adjusted by the content of a colorant or the like.

The ink set (1) may include three or more types of inks. When the ink set (1) includes three or more types of inks, it is sufficient that the ratio of thixotropic indices [(TB)/(TA)] of at least two types of inks is 1.04 or more, and the ink set (1) may include one or more types of inks that do not satisfy the requirement that the ratio of thixotropic indices (TB)/(TA) is 1.04 or more in relation to other inks. As an example of the combination of inks, for example, the ink set (1) may include one type of ink corresponding to the ink (A) having a low thixotropic index, and one or more types of inks corresponding to the ink (B) having a high thixotropic index. The ink set (1) may include one type of ink corresponding to the ink (B) having a high thixotropic index, and multiple types of inks corresponding to the ink (A) having a low thixotropic index. The ink set (1) may include multiple combinations of inks having a ratio of thixotropic indices [(TB)/(TA)] of 1.04 or more.

More specific configuration examples of the ink set (1) include: the ink set (1) including a dark black ink as the ink (A), a light black ink as the ink (B), and one or more types of inks selected from the group consisting of cyan ink, magenta ink, and yellow ink having any thixotropic index; the ink set (1) including one or more types of black ink with different shading as an ink (A1) and an ink (B1), and one or more types of ink with varying shades and having the same hue as ink (AX) and ink (BX); and the ink set (1) including one or more types of black ink with varying shades as the ink (A1) and the ink (B1), and one or more types of ink with varying shades and having the same hue as the ink (AX) and the ink (BX), and one or more types of inks having any thixotropic index.

The two types of inks included in the ink set (1) need only contain a colorant, a surfactant, and an organic solvent, and may be aqueous ink or oil-based ink, for example. In particular, when the ink is an oil-based ink, the effect of the present disclosure will be more prominent. Hereinafter, an oil-based ink will be described as an example of an ink.

One type of colorant may be used alone, or two or more types of colorants may be used in combination for the oil-based ink. The colorant is preferably non-oil-soluble, and in particular, the colorant has preferably significantly low solubility in a non-aqueous solvent contained in the oil-based ink. As for the degree of oil insolubility, for example, the amount of colorant soluble in 100 g of a non-aqueous solvent contained in the oil-based ink is preferably 3 g or less, more preferably 1 g or less, and particularly preferably, 0.5 g or less, under the condition of 23° C. When multiple types of colorants are used, the soluble amount as mentioned above applies to the soluble amount for each colorant.

Examples of the colorant include different types of pigments. Examples of the pigments include organic pigments such as azo pigments, phthalocyanine pigments, polycyclic pigments, dyed lake pigments, and the like; and inorganic pigments such as carbon black and metal oxides. The azo pigments include soluble azo lake pigments, insoluble azo pigments, condensed azo pigments, and the like. The phthalocyanine pigments include metal phthalocyanine pigments, metal-free phthalocyanine pigments and the like. Examples of the polycyclic pigment include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, diketopyrrolopyrrole (DPP) and the like. Examples of carbon black include furnace carbon black, lamp black, acetylene black, and channel black. Examples of the metal oxide include titanium oxide and zinc oxide.

The median diameter of the pigment in the ink is preferably 300 nm or less, and more preferably 200 nm or less, from the viewpoint of storage stability and ejection stability of the oil-based ink. The median diameter of the pigment in the ink may be, for example, 50 to 300 nm or 100 to 200 nm.

The content of the colorant in the oil-based ink is not particularly limited, but may be, for example, 1 to 30% by mass from the viewpoint of surface density of the printed matter and the viscosity of the ink.

The oil-based ink may contain an extender pigment if necessary. One type of extender pigment may be used alone, or two or more types of extender pigments may be used in combination. When the oil-based ink contains an extender pigment, the thixotropic index tends to increase. Examples of extender pigments include talc, diatomaceous earth, calcium carbonate, barium carbonate, barium sulfate, alumina white, silica, kaolin, mica, acid clay, activated clay, bentonite, and the like. The median diameter of the extender pigment is not particularly limited, but may be in the range of 50 to 300 nm, for example.

When the oil-based ink contains an extender pigment, the content thereof is suitably adjusted according to a desired thixotropic index, and may be in the range of 0.5 to 15% by mass, for example.

As described above, it is possible to adjust the thixotropic index of the oil-based ink containing an extender pigment. The oil-based ink may contain a thickener as another method for adjusting the thixotropic index. One type of thickener may be used alone, or two or more types of thickeners may be used in combination. An example of the thickener is Esben series of Hojun Co., Ltd. When the oil-based ink contains a thickener, the content of the thickener is suitably adjusted according to a desired thixotropic index or the like, and may be in the range of, for example, 0.5 to 15% by mass.

One type of dispersant may be used alone, or two or more types of dispersants may be used in combination. Examples of dispersants include a polymeric dispersant, a surfactant-type dispersant, and the like.

Examples of commercially available products of the polymeric dispersant include, TEGO Disperse series including “TEGO DISPERS 740 W”, “TEGO DISPERS 750 W”, “TEGO DISPERS 755 W”, “TEGO DISPERS 757 W”, and “TEGO DISPERS 760 W”, manufactured by EVONIK Industries AG; Solsperse series including “Solsperse 11200”, “Solsperse 13940”, “Solsperse 16000”, “Solsperse 17000”, “Solsperse 18000”, “Solsperse 19000”, “Solsperse 20,000”, “Solsperse 22000”, “Solsperse 24000”, “Solsperse 27000”, “Solsperse 28000”, “Solsperse 32000”, “Solsperse 38500”, “Solsperse 39000”, “Solsperse 41000”, “Solsperse 41090”, “Solsperse 43000”, “Solsperse 44000”, “Solsperse 46000”, and “Solsperse 71000”, manufactured by Lubrizol Japan Ltd.; Joncryl series including “Joncryl 57”, “Joncryl 60”, “Joncryl 62”, “Joncryl 63”, “Joncryl 71”, and “Joncryl 501”, manufactured by BASF Japan Ltd.; “DISPERBYK-102”, “DISPERBYK-185”, “DISPERBYK-190”, “DISPERBYK-193”, “DISPERBYK-199”, and the like, manufactured by BYK JAPAN KK; “Polyvinylpyrrolidone K-30”, “Polyvinylpyrrolidone K-90”, and the like, manufactured by DKS Co., Ltd.; and “Antalon V200”, manufactured by Ashland Japan Co., Ltd.

Examples of commercially available surfactant-type dispersants include anionic surfactants such as DEMOL series including “DEMOL P”, “DEMOL EP”, “DEMOL N”, “DEMOL RN”, “DEMOL NL”, “DEMOL RNL”, and “DEMOL T-45”, manufactured by Kao Corporation; and nonionic surfactants such as Emulgen series including “Emulgen A-60”, “Emulgen A-90”, “Emulgen A-500”, “Emulgen B-40”, “Emulgen L-40”, and “Emulgen 420”, manufactured by Kao Corporation.

The content of the dispersant in the oil-based ink is suitably adjusted according to, for example, the type and content of the colorant, and may be in the range of 1 to 20% by mass, for example.

The oil-based ink contains a non-aqueous solvent as an organic solvent. One type of non-aqueous solvent may be used alone, or two or more types of non-aqueous solvents may be used in combination. The non-aqueous solvent may be either a non-polar organic solvent or a polar organic solvent. The non-aqueous solvent may be a water-insoluble organic solvent that does not mix uniformly with the same volume of water at 1 atm and at a temperature of 20° C. The oil-based ink may contain other organic solvents to the extent that it can form a single phase with the non-aqueous solvent.

Examples of the non-polar organic solvent include petroleum hydrocarbon solvents such as aliphatic hydrocarbon solvents, alicyclic hydrocarbon solvents, and aromatic hydrocarbon solvents. Examples of aliphatic hydrocarbon solvents and alicyclic hydrocarbon solvents include non-aqueous solvents such as paraffinic, isoparaffinic, and naphthenic solvents. Examples of commercially available products of the solvents mentioned above include “No. 0 Solvent L”, “No. 0 Solvent M”, “No. 0 Solvent H”, “Cactus normal paraffin N-10”, “Cactus normal paraffin N-11”, “Cactus normal paraffin N-12 D”, “Cactus normal paraffin N-13”, “Cactus normal paraffin N-14”, “Cactus normal paraffin YHNP”, “Cactus normal paraffin SHNP”, “Isozol 300”, “Isozol 400”, “Teclean N 16”, “Teclean N20”, “Teclean N22”, “AF Solvent No. 4”, “AF Solvent No. 5”, “AF Solvent No. 6”, “AF Solvent No. 7”, “Naphtezol 160”, “Naphtezol 200”, “Naphtezol 220”, manufactured by ENEOS Corporation; “Isopar G”, “Isopar H BHT”, “Isopar L”, “Isopar M”, “Exol D40”, “Exol D60”, “Exol D80”, “Exol D1110”, and “Exol D130”, manufactured by ExxonMobil Corporation; “Moresco White P-60”, “Moresco White P-70”, “Moresco White P-80”, “Moresco White P-100”, “Moresco White P-120”, “Moresco White P-150”, “Moresco White P-200”, “Moresco White P-260”, and “Moresco White P-350 P”, manufactured by MORESCO Corporation. Examples of the aromatic hydrocarbon solvent include “Solvesso 100”, “Solvesso 150”, and “Solvesso 200”, “Solvesso 200ND”, manufactured by ExxonMobil Corporation. An initial distillation point of the petroleum hydrocarbon solvent is preferably 100° C. or higher, more preferably 150° C. or higher, and particularly preferably 200° C. or higher. The initial distillation point can be measured according to JIS K0066 “Distillation test method for chemical products”.

The polar organic solvent preferably includes a fatty acid ester solvent, a higher alcohol solvent, a higher fatty acid solvent, or the like. Examples of the fatty acid ester solvent include isononyl isononanoate, isodecyl isononanoate, isotridecyl isononanoate, methyl laurate, isopropyl laurate, hexyl laurate, isopropyl myristate, octyldodecyl myristate, isopropyl palmitate, hexyl palmitate, isooctyl palmitate, isostearyl palmitate, methyl oleate, ethyl oleate, isopropyl oleate, butyl oleate, hexyl oleate, methyl linoleate, ethyl linoleate, isobutyl linoleate, butyl stearate, hexyl stearate, isooctyl stearate, isopropyl isostearate, 2-octyldecyl pivalate, soybean oil fatty acid methyl ester, soybean oil fatty acid isobutyl ester, tall oil fatty acid methyl ester, tall oil fatty acid isobutyl ester, and the like, having 13 or more carbon atoms, preferably 16 to 30 carbon atoms in 1 molecule; Examples of higher alcohol-based solvents include isomyristyl alcohol, isopalmityl alcohol, isostearyl alcohol, oleyl alcohol, isoeicosyl alcohol, decyltetradecanol, and the like, having 6 or more carbon atoms, preferably 12 to 20 carbon atoms in 1 molecule; Examples of higher fatty acid solvents include lauric acid, isomyristic acid, palmitic acid, isopalmitic acid, a-linolenic acid, linoleic acid, oleic acid, isostearic acid, and the like, having 12 or more carbon atoms, preferably 14 to 20 carbon atoms in 1 molecule. The boiling point of polar organic solvents such as fatty acid ester solvents, higher alcohol solvents, and higher fatty acid solvents is preferably 150° C. or higher, more preferably 200° C. or higher, and even more preferably 250° C. or higher. The non-aqueous solvents having a boiling point of 250° C. or higher include non-aqueous solvents having no boiling point.

The content of the non-aqueous solvent in the oil-based ink is suitably adjusted according to the desired viscosity of the oil-based ink, and may be, for example, in the range of 20 to 95% by mass.

The oil-based ink may contain a resin if necessary. One type of resin may be used alone, or two or more types of resins may be used in combination. It is preferable that the resin is oil-insoluble, and in particular, it is preferable that the resin has low solubility in the non-aqueous solvent contained in the oil-based ink. As for the degree of oil-insolubility, for example, it is preferable that the amount of a resin soluble in 100 g of the non-aqueous solvent contained in the oil-based ink is 3 g or less under the condition of 23° C. When multiple types of resins are used, the soluble amount as mentioned above applies to the soluble amount for each resin. The types of resins are not particularly limited, and examples of the types of resins include acrylic resins, urethane resins, polyester resins, alkyd resins, silicone resins, and the like.

The oil-based ink may contain various additives, as necessary. As the additives, an anti-clogging agent for nozzles, an antioxidant, a conductivity regulator, a viscosity adjuster, a surface tension adjuster, an oxygen absorber, and the like may be added, as appropriate.

The method of producing the oil-based ink is not particularly limited, but for example, a colorant, a dispersant, an organic solvent, and other optional components may be blended and mixed to produce the oil-based ink. At the time of mixing, dispersion treatment may be performed by a bead mill.

The viscosity of the ink contained in the ink set (1) is adjusted, as appropriate, from the viewpoint of the ejection performance of the inkjet regardless of the type of ink, that is, whether the ink is an aqueous ink or an oil-based ink. The viscosity of the ink may be about the same as that of a general inkjet ink, and may be in the range of 9 to 13 mPa s at 23° C., for example. The method of measuring the viscosity is as described above.

The method for inkjet printing using the ink set (1) according to the embodiment is not particularly limited, and any method such as a piezoelectric, electrostatic, or thermal method may be used. When an inkjet recording device is used, ink is preferably ejected from an inkjet head based on a digital signal, and ejected ink droplets adhere to a print medium.

The print medium is not particularly limited, and a printing paper such as plain paper, coated paper, or special paper, a cloth, a porous sheet, or an adhesive sheet having an adhesive layer on the back surface thereof as a base material can be used. When the ink is an oil-based ink, printing paper such as plain paper or coated paper may be preferably used from the viewpoint of permeability of a non-aqueous solvent.

Here, plain paper refers to paper on which an ink receiving layer, a film layer, or the like is not formed on ordinary paper. Examples of plain paper include high quality paper, medium quality paper, PPC paper, rough paper, recycled paper, and the like. Plain paper includes fibers having a thickness of several m to several tens of m that form voids of several tens to several hundreds of m, allowing non-aqueous solvents to penetrate easily.

As the coated paper, inkjet coated paper such as matte paper, glossy paper, and semi-glossy paper, or what is known as coated printing paper can be preferably used. Here, the coated printing paper refers to printing paper conventionally used in letterpress printing, offset printing, gravure printing, and the like. The coated printing paper includes a coating layer formed on the surface of the high quality paper, the medium quality paper by using a coating material containing an inorganic pigment such as clay or calcium carbonate, and a binder such as starch. The coated printing paper is classified into fine coated paper, high-quality lightweight coated paper, medium-quality lightweight coated paper, high-quality coated paper, medium-quality coated paper, art paper, cast coated paper and the like according to the coating amount of the coating material and the coating method.

One embodiment of a method of producing printed matter provides a method of producing printed matter using two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], the method comprising applying an ink (A) having a lower thixotropic index to a print medium, and then applying an ink (B) having a higher thixotropic index to a print medium to be overlayed on at least a part of an application region of the ink (A), wherein the two types of inks each include a colorant, a dispersant, and an organic solvent, and the ratio of the thixotropic index of the ink (B) having a higher thixotropic index (TB) to the thixotropic index of the ink (A) having a lower thixotropic index (TA) [(TB)/(TA)] is 1.04 or more.

The method of producing the printed matter can be performed by using, for example, the ink (A) and the ink (B) included in the ink set described above, as two types of inkjet inks.

In the method of producing printed matter, after applying the ink (A) having a lower thixotropic index to a print medium, the ink (B) having a higher thixotropic index is applied to be overlayed on at least a part of an application region of the ink (A). The application of the ink (A) and the application of the ink (B) may be performed in succession, or a step of applying another ink may be interposed between the application of the ink (A) and the application of the ink (B). Another type of ink or other two or more types of ink may be used.

In a method of producing printed matter, when there are multiple types of inks with overlayed application regions, it is sufficient that at least two types of inks are in a relationship between the ink (A) and the ink (B). In view of obtaining an image of higher image quality, it is preferable that the relationship between the ink (A) and the ink (B) is established in all of the inks with overlayed application regions. It should be noted that the overlayed application regions refer to regions where the application regions are intentionally overlayed in order to obtain a desired color tone, and this does not apply to regions where the application regions are unintentionally overlayed due to ink bleeding or the like on a print medium.

The ink set according to one embodiment is an ink set (hereinafter also referred to as “ink set(2)”) including two types of oil-based inkjet inks having different thixotropic indices calculated by the following formula: thixotropic index=[Viscosity of oil-based inkjet ink measured at 23° C. and at a shear rate of 53.6 s⁻¹]/[Viscosity of oil-based inkjet ink measured at 23° C. and at a shear rate of 1000 s⁻¹], wherein a ratio of a thixotropic index of an oil-based ink (β) having a higher thixotropic index (Tβ) to a thixotropic index of an oil-based ink (α) having a lower thixotropic index (Tα) [(Tβ)/(Tα)] is 1.04 or more.

Examples of the oil-based ink (α) include oil-based inks among the inks (A) included in the ink set (1). Examples of the oil-based ink (β) include oil-based inks among the inks (B) included in the ink set (1).

The ratio of the thixotropic index of the oil-based ink (β) (Tβ) to the thixotropic index of the oil-based ink (α) (Tα) [(Tβ)/(Tα)] is 1.04 or more. The upper limit value is not particularly limited, but may be 2 or less, 1.5 or less, or 1.2 or less, for example, from the viewpoint of a balance with the ejection performance of the inkjet. As described above. The method of measuring the viscosity of the ink used for calculating the thixotropic index is as described above.

The types of colorant contained in the oil-based ink (α) and the oil-based ink (β), the color tone of the ink, and the like are not particularly limited, and the ink may be of any color. For example, inks in a relationship between dark and light may be used. As a specific example, the oil-based ink (α) may be a dark black ink and the oil-based ink (β) may be a light black ink. Further, the oil-based ink (α) and the oil-based ink (β) may have the same hue. The oil-based ink (α) may be a dark-colored ink and the oil-based ink (β) may be a light-colored ink. The shade of the ink can be adjusted by the content of the colorant or the like.

The ink set (2) may include three or more types of oil-based inks. When the ink set (2) includes three or more kinds of oil-based inks, it is sufficient that the ratio of the thixotropic indices [(Tβ)/(Tα)] of at least two types of oil-based inks is 1.04 or more, and the ink set (2) may include one or more types of oil-based inks that do not satisfy the requirement of the ratio of the thixotropic indices [(Tβ)/(Tα)] being 1.04 or more in relation to other oil-based inks. As an example of a combination of the oil-based inks, the ink set (2) may include one type of ink corresponding to the oil-based ink (α) and one or more types of oil-based inks corresponding to the oil-based ink (β). The ink set (2) may include multiple types of inks corresponding to the oil-based ink (α) and one type of oil-based ink corresponding to the oil-based ink (β). The ink set (2) may include a plurality of combinations of oil-based inks having a ratio of the thixotropic indices [(Tβ)/(Tα)] of 1.04 or more.

More specific configuration examples of the ink set (2) are as follows: the ink set (2) including a dark black ink as the oil-based ink (α), a light black ink as the oil-based ink (β), and one or more types of ink selected from the group consisting of cyan ink, magenta ink, and yellow ink having any thixotropic index; the ink set (2) including a black ink with varying shades as oil-based inks (α1) and (β1), and one or more types of shade ink having the same hue, as oil-based inks (αX) and (βX); an ink set (2) including a black ink with varying shades as the oil-based inks (α1) and (β1), one or more types of ink with varying shades and having the same hue as oil-based inks (αX) and (βX), and one or more types of ink having any thixotropic index.

The viscosity of the oil-based ink included in the ink set (2) is suitably adjusted from the viewpoint of the ejection performance of the inkjet. The viscosity of the oil-based ink may be about the same as that of a general inkjet ink, and may be in the range of 9 to 13 mPa s at 23° C., for example. The viscosity measurement method is as described above.

The ink set (2) can be particularly preferably used when, for example, two or more types of inks are applied in layers to adjust the color tone or the like. Specifically, after the oil-based ink (α) is applied to the print medium, the oil-based ink (β) is applied to be overlayed on at least a part of the application region of the oil-based ink (α), so that it is possible to reduce penetration of the oil-based ink (β) into the print medium due to an influence of an organic solvent contained in the oil-based ink (α) applied first. Thus, the colorant contained in the oil-based ink (β) sufficiently remains on the surface of the print medium, and a print having excellent image density can be obtained. In addition, it is not necessary to apply the oil-based ink (β) in excess in order to increase the image density, so that the leakage of the ink from the back can be suppressed.

Some embodiments according to the present disclosure are described below.

<1> An ink set including two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], wherein the two types of inks each include a colorant, a dispersant, and an organic solvent; a ratio of a thixotropic index of an ink (B) having a higher thixotropic index (TB) to a thixotropic index of an ink (A) having a lower thixotropic index (TA) [(TB)/(TA)] is 1.04 or more; and the ink (B) is applied to a print medium to be overlayed on at least a part of an application region of the ink (A) after applying the ink (A) to the print medium.

<2> The ink set according to <1>, wherein the ratio of the thixotropic index of the ink (B) (TB) to the thixotropic index of the ink (A) (TA) [(TB)/(TA)] is 1.20 or less.

<3> The ink set according to <1>, wherein the ink (A) is a dark black ink and the ink (B) is a light black ink.

<4> The ink set according to <1>, wherein the ink (A) and the ink (B) have the same hue; and the ink (A) is a dark-colored ink, and the ink (B) is a light-colored ink.

<5> The ink set according to <1>, wherein the ratio of the thixotropic index of the ink (B) (TB) to the thixotropic index of the ink (A) (TA) [(TB)/(TA)] is 1.04 or more, and 1.20 or less, and the ink (A) is a dark black ink and the ink (B) is a light black ink.

<6> The ink set according to <1>, wherein the ratio of the thixotropic index of the ink (B) (TB) to the thixotropic index of the ink (A) (TA) [(TB)/(TA)] is 1.20 or less, the ink (A) and the ink (B) have the same hue, the ink (A) is a dark-colored ink, and
the ink (B) is a light-colored ink.

<7> The ink set according to any one of <1> to <6>, wherein the viscosity of the ink (A) and the viscosity of the ink (B) are independently in the range of 9 to 13 mPa s.

<8> A method of producing printed matter using two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], the method including applying an ink (A) having a lower thixotropic index to a print medium, and then applying an ink (B) having a higher thixotropic index to a print medium to be overlayed on at least a part of an application region of the ink (A), wherein the two types of inks including a colorant, a dispersant, and an organic solvent, and a ratio of a thixotropic index of an ink (B) (TB) to a thixotropic index (TA) of an ink (A) [(TB)/(TA)] is 1.04 or more.

<9> An ink set including two types of oil-based inkjet inks having different thixotropic indices calculated by the following formula: thixotropic index=[Viscosity of oil-based inkjet ink measured at 23° C. and at a shear rate of 53.6 s⁻¹]/[Viscosity of oil-based inkjet ink measured at 23° C. and at a shear rate of 1000 s⁻¹], wherein a ratio of a thixotropic index of an oil-based ink (β) having a higher thixotropic index (Tβ) to a thixotropic index of an oil-based ink (α) having a lower thixotropic index (Tα) [(Tβ)/(Tα)] is 1.04 or more.

<10> The ink set according to <9>, wherein the ratio of the thixotropic index of the oil-based ink (β) (Tβ) to the thixotropic index of the oil-based ink (α) (Tα) [(Tβ)/(Tα)] is 1.20 or less.

<11> The ink set according to <9>, in which the oil-based ink (α) is a dark black ink and the oil-based ink (β) is a light black ink.

<12> The ink set according to <9>, in which the oil-based ink (α) and the oil-based ink (β) have the same hue; and the oil-based ink (α) is a dark-colored ink and the oil-based ink (β) is a light-colored ink.

<13> The ink set according to <9>, wherein the ratio of the thixotropic index of the oil-based ink (β) (Tβ) to the thixotropic index of the oil-based ink (α) (Tα) [(Tβ)/(Tα)] is 1.04 or more, and 1.20 or less, and the oil-based ink (α) is a dark black ink, and the oil-based ink (β) is a light black ink.

<14> The ink set according to <9>, wherein the ratio of the thixotropic index of the oil-based ink (β) (Tβ) to the thixotropic index of the oil-based ink (α) (Tα) [(Tβ)/(Tα)] is 1.04 or more, and 1.20 or less, the oil-based ink (α) and the oil-based ink (β) have the same hue, and the oil-based ink (α) is a dark-colored ink, and the oil-based ink (β) is a light-colored ink.[Examples]

Hereinafter, the present invention will be described in detail with reference to Examples. The present invention is not limited to the following Examples. Throughout the following Examples and Comparative Examples, the common components are the same unless otherwise described. “%” represents “% by mass” unless otherwise described.

### [Production of Pigment Dispersion 1 to 12]

Components were blended at the ratio shown in Table 1, and dispersed using a bead mill (“DYNO-MILL MULTI-LAB”) manufactured by Shinmaru Enterprises Corporation, to obtain pigment dispersion 1 to 12.

The details of the components in Table 1 are as follows.
Colorant 1: Carbon black, “SB 200” manufactured by Asahi Carbon Co., Ltd.
Colorant 2: Phthalocyanine blue pigment, “FASTOGEN BLUE FA5380” manufactured by DIC Corporation
Extender pigment 1: Silica, “AEROSIL R976” manufactured by NIPPON AEROSIL CO., LTD.
Extender pigment 2: Calcium carbonate, manufactured by Kondo Lime Industry Co., Ltd.
Thickener: “Esben N-400” manufactured by Hojun Co., Ltd.
Dispersant 1: “Antalon V200” manufactured by Ashland Japan Co., Ltd.
Dispersant 2: “Solsperse 18000” manufactured by The Lubrizol Corporation
Organic solvent 1: “ExolD-130” manufactured by ENEOS Corporation

TABLE 1

| Pigment Dispersion | | 1 | 2 | 3 | 4 | 5 | 6 | 7 | 8 | 9 | 10 |
|---|---|---|---|---|---|---|---|---|---|---|---|
| Colorant 1 | [% by mass] | 30.0 | 30.0 | 30.0 | 30.0 | 30.0 | | | | | |
| Colorant 2 | [% by mass] | | | | | | 30.0 | 30.0 | 30.0 | 30.0 | 30.0 |
| Extender Pigment 1 | [% by mass] | 10.0 | | | 15.0 | | 10.0 | | | 15.0 | |
| Extender Pigment 2 | [% by mass] | | 10.0 | | | | | 10.0 | | | |
| Thickener | [% by mass] | | | 10.0 | | | | | 10.0 | | |
| Dispersant 1 | [% by mass] | 10.0 | 10.0 | 10.0 | 10.0 | 10.0 | 10.0 | 10.0 | 10.0 | 10.0 | 10.0 |
| Dispersant 2 | [% by mass] | 10.0 | 10.0 | 7.5 | 12.5 | 5.0 | 5.0 | 5.0 | 5.0 | 5.0 | 5.0 |
| Organic Solvent 1 | [% by mass] | 40.0 | 40.0 | 42.5 | 32.5 | 55.0 | 45.0 | 45.0 | 45.0 | 40.0 | 55.0 |
| Total | [% by mass] | 100.0 | 100.0 | 100.0 | 100.0 | 100.0 | 100.0 | 100.0 | 100.0 | 100.0 | 100.0 |

### Examples 1 to 8 and Comparative Examples 1 and 2

Pigment dispersions and organic solvents 1 and 2 were blended at the ratios shown in Tables 2 and 3 to prepare respective inks and ink sets. The viscosity of the ink used for calculating the thixotropic index was measured using a rheometer MCR 302, manufactured by Anton Paar GmbH. The ink sets were loaded into a line-type inkj et printer (OR-PHIS FW5230, manufactured by RISO KAGAKU CORPORATION), and a solid image of the ink (A) was printed at 30 pl on one side of plain paper (Ideal Paper Multi manufactured by RISI KAKU, Ltd.), and then a solid image of the ink (B) was printed at 20 pl overlayed on the printing area of the ink (A). The printing was successively performed for 100 sheets to obtain printed matter. The obtained printed matter was subjected to evaluation tests using the following methods. The results are shown in Tables 2 and 3. In Comparative Example 1, a solid image of the ink (B) was printed at 30 pl, and then a solid image of the ink (A) was printed at 20 pl overlayed on the printing area of the ink (B).

The details of components in Tables 2 and 3 are as follows:
Pigment dispersant 1 to 12: Pigment dispersant 1 to 12 obtained as described above
Organic solvent 2: Octyldodecyl myristate, manufactured by KOKYU ALCOHOL KOHYO CO., LTD.
Organic solvent 3: “AF Solvent No. 5” manufactured by ENEOS Corporation.

### [Evaluation for Surface Density of Printed Matter]

After leaving the printed matter at room temperature for 24 hours, one sheet was selected at random from the printed matter, and the OD value of the surface was measured with an optical densitometer (RD 920, manufactured by Macbeth Co) and evaluated based on the following criteria:
A: OD value of 1.10 or more
B: OD value of less than 1.10

### [Evaluation of Strike-Through of Printed Matter]

After leaving the printed matter at room temperature for 24 hours, one sheet was selected at random from the printed matter, and the OD value of the back side of the sheet was measured using an optical densitometer (RD 920, manufactured by Macbeth Co.) and evaluated based on the following criteria:
A: OD value of less than 0.13
B: OD value of 0.13 or more

### [Evaluation of Ink Mist]

One sheet was selected at random from the printed matter, and the edge of the solid image was observed. The degree of mist stain was visually confirmed for each of the ink (A) and the ink (B), and evaluated based on the following criteria:
A: No stain can be confirmed around the image, or almost no stain can be found, and there is no problem in practical use.
B:Stain can be found around the image.

### [Evaluation of Conveyance Roller Stain]

After successive printing of 100 sheets, white paper was passed through the printer, and the presence or absence of ink adhered to the white paper was visually confirmed and evaluated based on the following criteria:
A: No adhesion of ink, or almost no adhesion of ink, can be found, and there is no problem in practical use.
B: Adhesion of ink can be seen.

TABLE 2

| | | Example 1 | | Example 2 | | Example 3 | | Example 4 | | Example 5 | |
|---|---|---|---|---|---|---|---|---|---|---|---|
| Ink | | (A) | (B) | (A) | (B) | (A) | (B) | (A) | (B) | (A) | (B) |
| Dispersion 1 | [% by mass] | | 15.00 | | | | | | | | |
| Dispersion 2 | [% by mass] | | | | 15.00 | | | | | | |
| Dispersion 3 | [% by mass] | | | | | | 15.00 | | | | |
| Dispersion 4 | [% by mass] | | | | | | | | 15.00 | | |
| Dispersion 5 | [% by mass] | 33.33 | | 33.33 | | 33.33 | | 33.33 | | | |
| Dispersion 6 | [% by mass] | | | | | | | | | | 10.00 |
| Dispersion 10 | [% by mass] | | | | | | | | | 20.00 | |
| Organic Solvent 1 | [% by mass] | 26.67 | 45.00 | 26.67 | 45.00 | 26.67 | 25.00 | 26.67 | 25.00 | 40.00 | 50.00 |
| Organic Solvent 2 | [% by mass] | 40.00 | 40.00 | 40.00 | 40.00 | 40.00 | 60.00 | 40.00 | 60.00 | 40.00 | 40.00 |
| Total | [% by mass] | 100.00 | 100.00 | 100.00 | 100.00 | 100.00 | 100.00 | 100.00 | 100.00 | 100.00 | 100.00 |

| | | | | | | | | | | |
|---|---|---|---|---|---|---|---|---|---|---|
| Thixotropic Index | 1.02 | 1.06 | 1.02 | 1.08 | 1.02 | 1.20 | 1.02 | 1.22 | 1.01 | 1.05 |

| | | | | | |
|---|---|---|---|---|---|
| Ratio of Thixotropic Indices | 1.04 | 1.06 | 1.18 | 1.20 | 1.04 |
| Evaluation of | A | A | A | A | A |
| Front Concentration | | | | | |
| Evaluation of Strike-through | A | A | A | A | A |
| Evaluation of Mist for Ink (A) | A | A | A | A | A |
| Evaluation of Mist for Ink (B) | A | A | A | A | A |
| Evaluation of Transfer Roller | A | A | A | A | A |
| Contamination | | | | | |

TABLE 3

| | | | | | | | | Comparative | | Comparative | |
|---|---|---|---|---|---|---|---|---|---|---|---|
| | | Example 6 | | Example 7 | | Example 8 | | Example 1 | | Example 2 | |
| Ink | | (A) | (B) | (A) | (B) | (A) | (B) | (A) | (B) | (A) | (B) |
| Dispersion 5 | [% by mass] | | | | | | | 15.00 | 33.33 | | |
| Dispersion 7 | [% by mass] | | 10.00 | | | | | | | | |
| Dispersion 8 | [% by mass] | | | | 10.00 | | | | | | |
| Dispersion 9 | [% by mass] | | | | | | 10.00 | | | | |
| Dispersion 10 | [% by mass] | 20.00 | | 20.00 | | 20.00 | | | | 20.00 | 10.00 |
| Organic Solvent 1 | [% by mass] | 40.00 | 50.00 | 40.00 | 35.00 | 40.00 | 35.00 | 50.00 | 26.67 | 40.00 | 50.00 |
| Organic Solvent 2 | [% by mass] | 40.00 | 40.00 | 40.00 | 55.00 | 40.00 | 55.00 | 35.00 | 40.00 | 40.00 | 40.00 |
| Total | [% by mass] | 100.00 | 100.00 | 100.00 | 100.00 | 100.00 | 100.00 | 100.00 | 100.00 | 100.00 | 100.00 |

| | | | | | | | | | | |
|---|---|---|---|---|---|---|---|---|---|---|
| Thixotropic Index | 1.01 | 1.06 | 1.01 | 1.17 | 1.01 | 1.18 | 1.01 | 1.02 | 1.01 | 1.01 |

| | | | | | |
|---|---|---|---|---|---|
| Ratio of Thixotropic Indices | 1.05 | 1.16 | 1.17 | 1.01 | 1.00 |
| Evaluation of | A | A | A | B | B |
| Front Concentration | | | | | |
| Evaluation of Strike-through | A | A | A | B | B |
| Evaluation of mist for Ink (A) | A | A | A | A | A |
| Evaluation of mist for Ink (B) | A | A | A | A | A |
| Evaluation of Transfer Roller | A | A | A | A | A |
| Contamination | | | | | |

As shown in Tables 2 and 3, in Examples 2 to 8, two types of inkjet inks having a thixotropic index ratio of 1.04 or more were used. The ink (A) having a lower thixotropic index was applied first, and then the ink (B) having a higher thixotropic index was applied. As a result, printed matter having excellent surface density of an image was obtained. Moreover, the occurrence of strike-through of the ink, misting of the ink, and the occurrence of staining of a conveying roller were reduced. In Comparative Example 1, in which the ratio of the thixotropic index was less than 1.04 and the ink having a higher thixotropic index was applied first, and in Comparative Example 2, in which the ratio of the thixotropic index was less than 1.04, the surface density was low and strike-through of the ink also occurred.

1. An ink set comprising two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], wherein
the two types of inks each include a colorant, a dispersant, and an organic solvent,
a ratio of a thixotropic index of an ink (B) having a higher thixotropic index (TB) to a thixotropic index of an ink (A) having a lower thixotropic index (TA) [(TB)/(TA)] is 1.04 or more, and
the ink (B) is applied to a print medium to be overlayed on at least a part of an application region of the ink (A) after applying the ink (A) to the print medium.

2. The ink set according to claim 1, wherein the ratio of the thixotropic index of the ink (B) (TB) to the thixotropic index of the ink (A) (TA) [(TB)/(TA)] is 1.20 or less.

3. The ink set according to claim 1, wherein the ink (A) is a dark black ink, and the ink (B) is a light black ink.

4. The ink set according to claim 1, wherein
the ink (A) and the ink (B) have the same hue, and
the ink (A) is a dark-colored ink, and the ink (B) is a light-colored ink.

5. The ink set according to claim 1, wherein
the ratio of the thixotropic index of the ink (B) (TB) to the thixotropic index of the ink (A) (TA) [(TB)/(TA)] is 1.04 or more, and 1.20 or less, and
the ink (A) is a dark black ink and the ink (B) is a light black ink.

6. The ink set according to claim 1, wherein
the ratio of the thixotropic index of the ink (B) (TB) to the thixotropic index of the ink (A) (TA) [(TB)/(TA)] is 1.20 or less,
the ink (A) and the ink (B) have the same hue,
the ink (A) is a dark-colored ink, and
the ink (B) is a light-colored ink.

7. The ink set according to claim 1, wherein the viscosity of the ink (A) and the viscosity of the ink (B) are independently in the range of 9 to 13 mPa s.

8. A method of producing printed matter using two types of inkjet inks having different thixotropic indices calculated by the following formula: thixotropic index=[Viscosity of inkjet ink measured at 23° C. and at a shear rate of 53.6 s⁻¹]/[Viscosity of inkjet ink measured at 23° C. and at a shear rate of 1000 s⁻¹], the method comprising:
applying an ink (A) having a lower thixotropic index to a print medium, and then applying an ink (B) having a higher thixotropic index to a print medium to be overlayed on at least a part of an application region of the ink (A), wherein
the two types of inks each including a colorant, a dispersant, and an organic solvent, and
a ratio of a thixotropic index of the ink (B) (TB) to a thixotropic index of the ink (A) (TA) [(TB)/(TA)] is 1.04 or more.

9. An ink set including two types of oil-based inkjet inks having different thixotropic indices calculated by the following formula: thixotropic index=[Viscosity of oil-based inkjet ink measured at 23° C. and at a shear rate of 53.6 s⁻¹]/[Viscosity of oil-based inkjet ink measured at 23° C. and at a shear rate of 1000 s⁻¹], wherein a ratio of a thixotropic index of an oil-based ink (β) having a higher thixotropic index (Tβ) to a thixotropic index of an oil-based ink (α) having a lower thixotropic index (Tα) [(Tβ)/(Tα)] is 1.04 or more.

10. The ink set according to claim 9, wherein the ratio of the thixotropic index of the oil-based ink (β) (Tβ) to the thixotropic index of the oil-based ink (α) (Tα) [(Tβ)/(Tα)] is 1.20 or less.

11. The ink set according to claim 9, wherein the oil-based ink (α) is a dark black ink and the oil-based ink (β) is a light black ink.

12. The ink set according to claim 9, wherein
the oil-based ink (α) and the oil-based ink (β) have the same hue, and
the oil-based ink (α) is a dark-colored ink, and the oil-based ink (β) is a light-colored ink.

13. The ink set according to claim 9, wherein
the ratio of the thixotropic index of the oil-based ink (β) (Tβ) to the thixotropic index of the oil-based ink (α) (Tα) [(Tβ)/(Tα)] is 1.04 or more, and 1.20 or less, and
the oil-based ink (α) is a dark black ink, and the oil-based ink (β) is a light black ink.

14. The ink set according to claim 9, wherein
the ratio of the thixotropic index of the oil-based ink (β) (Tβ) to the thixotropic index of the oil-based ink (α) (Tα) [(Tβ)/(Tα)] is 1.04 or more, and 1.20 or less,
the oil-based ink (α) and the oil-based ink (β) have the same hue, and
the oil-based ink (α) is a dark-colored ink, and the oil-based ink (β) is a light-colored ink.
